(19) United States
(12) Patent Application Publication
(10) Pub. No.: US 2016/0002083 A1
(43) Pub. Date: Jan. 7, 2016

(54) MICRO-SIEVE SEPARATION AND COD DIVERSION IN WASTEWATER TREATMENT

(71) Applicant: GENERAL ELECTRIC COMPANY, Schenectady, NY (US)

(72) Inventor: Pierre Lucien COTE, Dundas (CA)

(73) Assignee: GENERAL ELECTRIC COMPANY, Schenectady, NY (US)

(21) Appl. No.: 14/769,367

(22) PCT Filed: Feb. 22, 2013
(86) PCT No.: PCT/US2013/027403

§ 371 Date: Aug. 20, 2015

(51) Int. Cl. C02F 9/00; B01D 33/044; B01D 33/15; C02F 1/00; B01D 33/76; C02F 3/30; C02F 1/52; C02F 1/44; C02F 3/02; B01D 33/06

(52) U.S. Cl. CPC C02F 9/00; C02F 3/02; B01D 33/044; B01D 33/15; B01D 33/06; B01D 33/76; C02F 3/30; C02F 1/52; C02F 1/44; C02F 1/004

(57) ABSTRACT

A wastewater treatment device is described in this specification having an aeration tank upstream of a micro-sieve. A process for treating wastewater comprises a step of treating wastewater by way of aeration with a hydraulic retention time of 6 hours or less, a solids retention time of 6 days or less, or both, to produce a first effluent. The first effluent is treated by way of a micro-sieve to produce a second effluent and a sludge. A portion of the sludge may be recycled to the aeration tank step. A portion of the sludge may be further treated in an anaerobic digester. The second effluent may be further treated, for example by way of one or more additional digestion steps or a further solid liquid separation step or both.

### FIELD OF THE INVENTION

Embodiments of the present invention relate to wastewater treatment.

### BACKGROUND

A micro-sieve is a solid-liquid separation device that may alternatively be referred to as a micro-screen or a micro-strainer. A micro-sieve operates by using well defined apertures, typically in a sheet form material, to block particles. The material may be in the form of an endless belt, a rotating drum, or rotating discs. The apertures typically have a size in the range from 10-1000 microns, which is measured as the diameter of a circle of equivalent area for non-circular openings. Commercial examples include rotating belt sieves by Salsnes or M2R, rotating disc filters by Estuagua and rotating drum filters by Passavant Geiger.

### SUMMARY OF THE INVENTION

A wastewater treatment device is described in this specification having an aeration tank upstream of a micro-sieve. A recycle conduit connects a feed side of the micro-sieve back to the aeration tank

A process for treating wastewater comprises a step of treating wastewater by way of aeration with a hydraulic retention time of 6 hours or less, a solids retention time of 6 days or less, or both, to produce a first effluent. The first effluent is treated by way of a micro-sieve to produce a second effluent and a sludge. A portion of the sludge may be recycled and re-treated as influent. A portion of the sludge may be further treated in an anaerobic digester. The second effluent may be further treated, for example by way of one or more additional digestion steps, a further solid liquid separation step, or both.

The device and process are useful, for example, for treating wastewater such as municipal sewage.

### BRIEF DESCRIPTION OF THE FIGURE

FIG. 1 is a process flow diagram of a wastewater treatment device.

### DETAILED DESCRIPTION

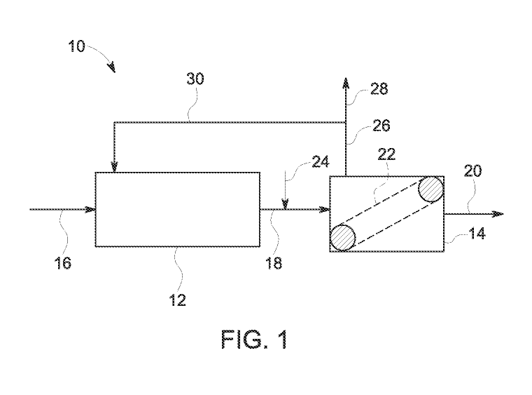

FIG. 1 shows a wastewater treatment device 10 having an aeration tank 12 and a micro-sieve 14. Suitable conduits, inlets and outlets allow for the flow of liquids to, from and within the wastewater treatment device 10. Influent 16 flows into the aeration tank 12. A first effluent 18 flows from the aeration tank 12 to the micro-sieve 14. A second effluent 20 flows from the micro-sieve 14 after passing through a screening material 22 in the micro-sieve 14. Optionally, a coagulant 24 may be added from a dosing device to the first effluent 18 or to the feed 16. Sludge 26, comprising solids rejected by the screening material 22, is withdrawn from the feed side of the micro-sieve 14. The sludge 26 is divided into waste sludge 28 and return sludge 30. The return sludge 30 is recycled to the aeration tank 12 directly or by being mixed with the influent 16. Optionally, a second aeration tank or zone of the aeration tank 12 may be provided in line with the recycle line carrying the return sludge 30.

In an embodiment, the aeration tank 12 has a hydraulic retention time (HRT) of 6 hours or less, for example in the range of 0.5 to 3 hours. The sludge retention time (SRT), alternatively called solids retention time, of the wastewater treatment device 10 is 6 days or less in an embodiment, or 3 days or less in an embodiment. The aeration tank 12 increases the removal of chemical oxygen demand (COD) from the influent 16 to the waste sludge 28 by the micro-sieve 14. Optionally, the device 10 may also function as a short SRT activated sludge process, a Stage A biological treatment or a contact stabilisation unit.

Optionally, the influent 16 may be municipal sewage or another type of raw wastewater. In that case, the influent 16 passes through one or pre-treatment steps before entering the aerobic reactor 12 as pre-treated raw sewage according to an embodiment. For example, the influent 16 may be screened or de-gritted or both. Screening may be done with a coarse screen, for example with openings in the range of 3 to 6 mm. De-gritting may be done, for example, in a vortex unit.

Waste sludge 28 may be disposed, applied to land, or optionally treated further in an anaerobic digester. As will be described further below, the micro-sieve 14 retains a substantial amount of particulate and colloidal (COD) in the sludge 26. When the waste sludge 28 is treated in an anaerobic digester, this increases the amount of COD that is digested anaerobically relative to a process using an ordinary gravity settler as a clarifier. Diverting COD to an anaerobic digester tends to decrease the energy consumption of a wastewater treatment process.

The second effluent 20 is optionally treated further by one or more biological nutrient removal (BNR) processes, by further solid-liquid separation, or both. For example, the second effluent 20 may be treated with an activated sludge process with the wastewater treatment device 10 replacing the primary clarifier in a known activated sludge treatment process. Alternatively, the influent 16 may be mixed liquor or another partially treated wastewater stream.

The micro-sieve 14 may be, for example, a rotating belt sieve, a rotating disc filter or a rotating drum filter. The screening material 22 may have openings with a size in the range from 10-1000 microns. The opening size of a circular opening is its diameter. The opening size of a non-circular opening is deemed to be the diameter of a circle having the same area as the non-circular opening. In an embodiment, the screening material 22 has openings with a size in the range of 100-500 microns.

In an embodiment, the micro-sieve 14 removes at least 50%, for example 50-80%, of the total suspended solids (TSS) of the influent 16 to the sludge 26. In an embodiment, the micro-sieve 14 also removes at least 40%, for example 40-80%, of the COD or biological oxygen demand (BOD) of the influent 16. Optionally, removal of COD and TSS to the sludge 26 can be increased by adding the coagulant 24. The coagulant 24 may be, for example, an inorganic coagulant such as a metal salt or a polymer. The coagulant 24 may be added to the first effluent 18 as it is flowing to the micro-sieve 14 or to the feed 16. The coagulant 24, or other chemicals added to the influent 16 or first effluent 18, may also precipitate phosphorus or act as a filter aid to increase the removal rate of the micro-sieve 14.

In an embodiment, a type of micro-sieve 14 is a rotating belt sieve (RBS). Suitable RBS units are available, for example, from Salsnes or M2R. The RBS may be equipped with an auger downstream of the screening surface 22 but ahead of a sludge outlet that allows concentrating the sludge 26 to a TSS concentration of 10% or more or 15% or more. At this concentration, the return sludge 30 flow rate is small, for example 20% or less of the influent 16 flow rate. For comparison, a conventional contact stabilisation process with a gravity settler can have a return activated sludge flow rate equal to or larger than the influent flow rate. The micro-sieve 14 also allows the aeration tank 12 to have a higher suspended solids concentration than would be possible with a gravity settler. Waste sludge 28 produced at a TSS concentration of 10% or more and can be fed directly into an anaerobic digester without pre-thickening. The high TSS concentration also allows a smaller anaerobic digester to obtain a specified hydraulic retention time. The micro-sieve 14 also removes solids such as trash or fibers that might otherwise damage equipment treating the second effluent 20 such as membranes.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A wastewater treatment device, comprising:
an aeration tank;
a micro-sieve; and
conduits connecting a source of an influent to the aeration tank, connecting an outlet of the aeration tank to the micro-sieve, and connecting an outlet from a feed side of the micro-sieve to the aeration tank.

2. The wastewater treatment device of claim 1, wherein the micro-sieve comprises a rotating belt sieve, a rotating disc filter, or a rotating drum filter.

3. The wastewater treatment device of claim 2, wherein the micro-sieve comprises a rotating belt sieve.

4. The wastewater treatment device of claim 3, wherein the rotating belt sieve comprises a solids concentrating auger.

5. The wastewater treatment device of claim 1, further comprising an anaerobic digester connected to the outlet from the feed side of the micro-sieve.

6. The wastewater treatment device of claim 1, wherein the influent is raw municipal sewage.

7. The wastewater treatment device of claim 5, further comprising a coarse screen and a vortex unit in line with the conduit connected to the source of the influent and the aerobic digester.

8. The wastewater treatment device of claim 1, wherein the micro-sieve comprises a screening material having openings having the area of a circle with a diameter in the range from 10-1000 microns.

9. The wastewater treatment device of claim 1, wherein the micro-sieve comprises a screening material having openings having the area of a circle with a diameter in the range from 100-500 microns.

10. The wastewater treatment device of claim 1, further comprising a coagulant dosing device in communication with the conduit connecting the outlet of the aerobic reactor to the micro-sieve.

11. A process for treating wastewater, the process comprising:
treating wastewater in an aeration tank with a hydraulic retention time of 6 hours or less, a solids retention time of 6 days or less, or both, to produce a first effluent; and
treating the first effluent by way of a micro-sieve to produce a second effluent and a sludge.

12. The process of claim 11, wherein the hydraulic retention time of the aeration tank is 3 hours or less.

13. The process of claim 12, wherein the solids retention time of the aeration tank is 3 days or less.

14. The process of claim 11, further comprising a step of recycling a portion of the sludge to the aeration tank.

15. (canceled)

16. The process of claim 11, further comprising a step of treating a portion of the sludge in an anaerobic digester.

17. The process of claim 11, wherein the micro-sieve removes at least 50% of the total suspended solids of the wastewater to the sludge.

18. The process of claim 11, wherein the micro-sieve removes at least 30% of the chemical oxygen demand of the wastewater to the sludge.

19. The process of claim 11, further comprising a step of adding a coagulant to the wastewater or the first effluent.

20. The process of claim 11, wherein the activated sludge has a total suspended solids concentration of 10% or more.

21. The process of claim 11, wherein the second effluent is treated using a membrane.
